(19) United States
(12) Patent Application Publication
(10) Pub. No.: US 2025/0378351 A1
(43) Pub. Date: Dec. 11, 2025

(54) Hybrid Quantum DNA Computing Process

(71) Applicant: Joshua MAY, Portland, OR (US)

(72) Inventor: Joshua MAY, Portland, OR (US)

(21) Appl. No.: 19/201,911

(22) Filed: May 7, 2025

Related U.S. Application Data
(60) Provisional application No. 63/656,103, filed on Jun. 5, 2024.
(60) Provisional application No. 63/688,436, filed on Aug. 29, 2024.

(51) Int. Cl. G06N 3/123; G06N 10/40

(52) U.S. Cl. CPC G06N 3/123; G06N 10/40

(57) ABSTRACT

Disclosed is a hybrid computational framework input preparation that uses classical computing methods to preprocess and encode the input data into formats suitable for both DNA and quantum systems that employ DNA computing for tasks that benefit from massive parallelism. For instance, use DNA hybridization and enzymatic reactions to perform combinatorial searches or optimization tasks. DNA's natural ability to process large datasets simultaneously can handle the initial stages of complex problem-solving. Combining the strengths of DNA and quantum computing, we can create a powerful hybrid computational paradigm capable of tackling complex problems more efficiently than either technology alone. This approach not only leverages the massive parallelism of DNA computing and quantum speedup but also opens new avenues for innovative research and practical applications.

### CROSS-REFERENCE TO RELATED APPLICATIONS

Not Applicable This application claims the benefit of Provisional Application Ser. No. 63/656,103 filed Jun. 5, 2024, and Provisional Application Ser. No. 63/688,436 filed Aug. 29, 2024, the entire contents of which is hereby expressly incorporated by reference herein.

### PRIOR ART

U.S. Pat. No. 11,823,010 issued on Nov. 21, 2023, to Pradeep Niroula et al., and is titled Accelerated Pattern Matching Method on a Quantum Computing System. This patent discloses a method of determining a pattern in a sequence of bits using a quantum computing system includes setting a first register of a quantum processor in a superposition of a plurality of string index states, encoding a bit string in a second register of the quantum processor, encoding a bit pattern in a third register of the quantum processor, circularly shifting qubits of the second register conditioned on the first register, amplifying an amplitude of a state combined with the first register in which the circularly shifted qubits of the second register matches qubits of the third register, measuring an amplitude of the first register and determining a string index state of the plurality of string index states associated with the amplified state, and outputting, by use of a classical computer, a string index associated with the first register in the measured state. While this patent discloses the use of a quantum process it does not use a DNA computing system.

U.S. Published application 2024/0104413 was published on Mar. 28, 2024, to Tador Mladeniv et al., and is titled Technologies for Hybrid Digital/Analog Processors for a Quantum Computer. This publication discloses a hybrid digital/analog processor for a quantum computer are disclosed. In the illustrative embodiment, a hybrid digital/analog processor may be able to process digital instructions as well as analog instructions. The digital instructions may be, e.g., read from or write to memory or registers, perform an arithmetic operation, perform a branch, etc. The analog instructions may be to, e.g., provide an analog voltage to a particular electrode of a qubit, provide an analog pulse to a qubit, measure a reflection of an analog signal from a qubit, etc. The integration of analog operations in the hybrid digital/analog processor can improve performance by, e.g., lowering latency and lowering power usage. While this publication discloses a hybrid computer system, the system is only a hybrid of digital and analog processors.

U.S. published application 2006/0121493 was published on Jun. 8, 2006, to Fumiyoshi Sasagawa and is titled DNA Computer and a Computation Method Using the Same. This publication discloses a DNA computer for carrying out computations using DNAs is provided with a dividing part for dividing a problem that is to be solved into a plurality of partial problems, and an operation part for obtaining a DNA sequence corresponding to a solution to the problem, by combining DNA sequences corresponding to solutions of the plurality of partial problem. While this publication is for a DNA computer it does not operate in a hybrid computing environment.

What is needed is a form of DNA computing that leverages the unique properties of DNA molecules and biochemical reactions to perform computations. The DNA computing system disclosed in this document offers a novel approach to solving problems beyond the reach of classical computers, with ongoing research focused on overcoming technical challenges and realizing practical DNA-based computing systems.

### BACKGROUND OF THE INVENTION

Most computer systems use a method of binary 0 of 1 to perform computation in a serial manner. While these computers appear fast in today's speed comparison, computation is limited to single computation or time-sharing computations to arrive at a solution. Quantum computers use qubits instead of binary bits to solve a problem more quickly. Qubits can be linked together to solve larger and more complex problems. Other advances are being made with DNA computers that can simultaneously solve problems. Combining the strengths of DNA and quantum computing, we can create a powerful hybrid computational paradigm capable of tackling complex problems more efficiently than either technology alone. This approach not only leverages the massive parallelism of DNA computing and quantum speedup but also opens new avenues for innovative research and practical applications.

### SUMMARY OF THE INVENTION

It is an object of the hybrid quantum DNA computing process to use a classical computing method to preprocess and encode the input data into formats suitable for both DNA and quantum systems. This includes translating classical data into DNA sequences and initializing qubit states.

It is an object of the hybrid quantum DNA computing process to employ DNA computing for tasks that benefit from massive parallelism. For instance, use DNA hybridization and enzymatic reactions to perform combinatorial searches or optimization tasks. DNA's natural ability to process large datasets simultaneously can handle the initial stages of complex problem-solving.

It is another object of the hybrid quantum DNA computing process to transfer the intermediate results from DNA computations to a quantum processor. This step involves translating DNA-encoded solutions into quantum states. Quantum computing can then perform sophisticated operations on these states, taking advantage of quantum parallelism and entanglement. Quantum computers use dilution refrigerators to maintain temperatures close to absolute zero, often below 10 millikelvins (−273.14° C.). Qubits need a dilution refrigerator to function properly.

It is another object of the hybrid quantum DNA computing process to include interfaces and protocols for seamless communication between DNA and quantum systems. Biochemical-to-quantum transducers that can convert molecular states into qubit states and vice versa. Quantum dots or other nanoscale devices could serve as intermediaries.

It is still another object of the hybrid quantum DNA computing process to leverage the strengths of both DNA and quantum computing. For example, using DNA computing for exhaustive searches or generating large solution spaces and quantum computing for refining solutions, optimizing parameters, or solving subproblems that benefit from quantum speedup.

It is another object of the hybrid quantum DNA computing process to apply quantum algorithms like Grover's search or the variational quantum eigen solver to refine these candidates and identify optimal solutions with higher precision. Grover's algorithm determines the superposition, interference, and phase inversion to systematically amplify the probability amplitude of correct states. In the initial step, each qubit is placed into a superposition state using the Hadamard gate, this means that the quantum system now exists in a superposition of all possible states simultaneously.

The oracle function marks the correct state by applying a phase flip, a physical operation that inverts the sign of the amplitude of the correct state. This phase flip sets up the conditions for constructive interference in the subsequent steps.

First, the quantum system is prepared in a superposition of all possible states. This is typically done using Hadamard gates, which transform the initial state, usually a state where all qubits are set to zero into an equal mixture of all possible states. The oracle function is designed to recognize the “correct” or “target” state. When applied, it flips the phase of this target state, changing its sign, while leaving all other states unchanged. This action effectively “marks” the target state within the quantum system.

The phase flip creates a difference between the target state and all other states, which is then exploited by the next step of the algorithm. Here, the diffusion operator comes into play. This operator amplifies the probability of the marked state being observed by using a process similar to constructive interference in waves. It does this by reflecting the state vector around the average of all the states' amplitudes, which results in increasing the likelihood of the target state being measured.

This process of applying the oracle function followed by the diffusion operator is repeated multiple times. With each iteration, the probability of observing the correct state increases, thanks to the amplification effect of the diffusion operator. Over a series of iterations, this process significantly boosts the chance of measuring the correct state, making it highly likely to be the result when the quantum system is observed.

To make this concept more concrete, consider a simple example involving a system with just two qubits. The goal might be to find a specific state, say “10.” Initially, the system is placed in a superposition where all four possible states (“00,” “01,” “10,” “11”) are equally likely. The oracle then flips the phase of the target state “10,” marking it. Afterward, the diffusion operator is applied, which effectively increases the probability of the target state through constructive interference. As a result, the chance of measuring “10” becomes significantly higher than that of the other states.

The deterministic nature of Grover's algorithm comes from the precise sequence of quantum gate operations, which systematically manipulate the system's probabilities by leveraging quantum principles like superposition and interference. The process is not random; instead, it's a carefully controlled series of steps that ensure the correct state is found efficiently and with high probability.

Grover's algorithm takes advantage of the unique properties of quantum mechanics to systematically increase the likelihood of finding the correct state. The oracle marks the correct state by flipping its phase, and the diffusion operator then amplifies its probability of being measured. Through this carefully orchestrated sequence of operations, the algorithm ensures that the correct state's probability is predictably and significantly enhanced.

The deterministic nature of the algorithm arises from the structured application of quantum gates that exploit the principles of superposition and interference. The process is governed by the following physical variables: Initially equal for all states, then modified by the oracle and diffusion operator. Phase Inversion: Introduced by the oracle to mark the correct state. Interference Pattern: Created by the diffusion operator to amplify the correct state.

Grover's algorithm exploits quantum mechanical properties to systematically increase the likelihood of the correct state through constructive interference. The physical operations such as phase flips by the oracle and reflections by the diffusion operator are deterministic and ensure that the correct state's probability amplitude is amplified predictably. This process is not random; it is a carefully orchestrated sequence of quantum operations that leverages the inherent properties of quantum systems.

Various objects, features, aspects, and advantages of the present invention will become more apparent from the following detailed description of preferred embodiments of the invention, along with the accompanying drawings in which like numerals represent like components.

### BRIEF DESCRIPTION OF DRAWINGS

FIG. 1 shows a block diagram of the hybrid quantum DNA computing process.

FIG. 2 shows a quantum processing system.

FIG. 4 shows a refrigerator structure.

FIG. 5 shows the temperature states within a quantum computer.

FIG. 5 shows a DNA processing system.

FIG. 6 shows a two-level problem.

FIG. 7 shows a multi-dimensional problem.

FIG. 8 shows three different scenarios for configuring the hybrid computer processing.

FIG. 9 shows another embodiment of a hybrid computational system.

### DETAILED DESCRIPTION OF THE INVENTION

It will be readily understood that the components of the present hybrid computing process, as generally described and illustrated in the drawings herein, could be arranged and designed in a wide variety of different configurations. Thus, the following more detailed description of the embodiments of the system and method of the present hybrid computing process, as represented in the drawings, is not intended to limit the scope of the hybrid computing process but is merely representative of various embodiments of the hybrid computing process. The illustrated embodiments of the hybrid computing process will be best understood by reference to the drawings, wherein like parts are designated by like numerals throughout.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

### ITEM NUMBERS AND DESCRIPTION

| | | |
|---|---|---|
| 18 two-level problem | 19 hybrid computing process | |
| 20 binary computer | 40 quantum processor | |
| 41 refrigerator | 50 35 K temperature | |
| 51 3 K temperature | 52 900 mK temperature | |
| 53 100 mK temperature | 54 10 mK temperature | |
| 55 attenuators | 56 low pass filter | |
| 57 band pass filter | 58A/58B isolators | |
| 59 circulator | 60 DNA processor | |
| 61 input side | 62 output side | 63 four nucleotides |
| 70 Drive | 71 Flux | |
| 72 Pump | 73 Output | |
| 74 High Electron Mobility Transistor (HEMT) | 75 sample | |
| 76 traveling-wave parametric amplifier 76 (TWPA) | 80 work | |
| 81 home | 82 store 1 | |
| 83 store 2 | 84 paths | |
| 90 DNA-based storage | 91 DNA storage module | |
| 92 Biochemical chamber module | 93 quantum solver module. | |

Hybrid Computational Framework Input Preparation uses classical computing methods to preprocess and encode the input data into formats suitable for both DNA and quantum systems that employ DNA computing for tasks that benefit from massive parallelism. For instance, use DNA hybridization and enzymatic reactions to perform combinatorial searches or optimization tasks. DNA's natural ability to process large datasets simultaneously can handle the initial stages of complex problem-solving. Combining the strengths of DNA and quantum computing, we can create a powerful hybrid computational paradigm capable of tackling complex problems more efficiently than either technology alone. This approach not only leverages the massive parallelism of DNA computing and quantum speedup but also opens new avenues for innovative research and practical applications.

FIG. 1 shows a block diagram of the hybrid quantum DNA computing process. In this embodiment a binary computer 20 is programmed for the parameters of a problem that will be solved having input data. Based upon the problem that is being solved the binary computer 20 can process the problem itself or can pass the problem to one or both quantum processing system 40 and DNA processing system 60. The binary computer 20 can choose to perform other tasks or can also work to process a solution. Once one or both quantum processing system 40 and the DNA processing system 60 have a solution the binary computer will provide the solution or the best solution to the problem. A more detailed description of these processing systems is described below.

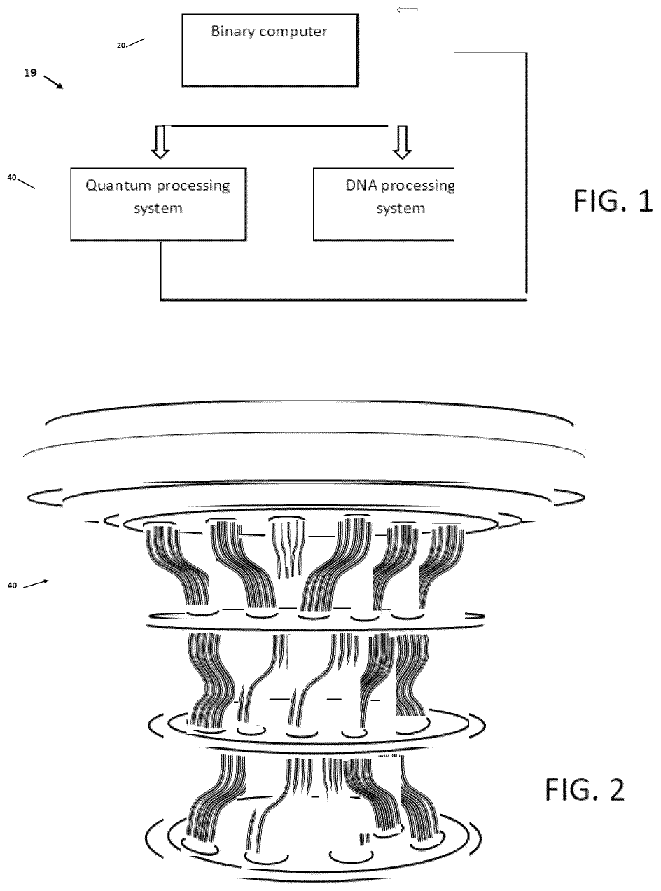

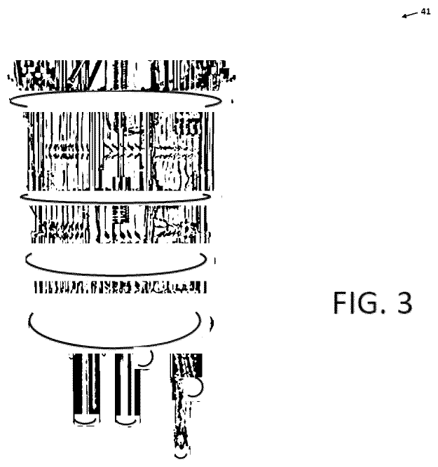

FIG. 2 shows a quantum processing system 40. Quantum computers operate based on the principles of quantum mechanics, fundamentally differing from classical computers that rely on classical physics. At the core of a quantum computer is the quantum bit or qubit, which, unlike classical bits that can be either 0 or 1, can exist in a state of 0, 1, or a superposition of both states. This unique property arises from quantum superposition, allowing qubits to represent multiple states simultaneously. Additionally, quantum entanglement enables qubits to become correlated such that the state of one qubit depends on the state of another, regardless of their physical separation. This entanglement permits parallel computations and non-classical behaviors.

### Quantum Computing Summary

Quantum computers use quantum gates to manipulate qubits, altering their quantum states based on the principles of quantum mechanics. During computation, qubits exist in superpositions, but upon measurement, these superpositions collapse to definite states (either 0 or 1), dictated by the probabilities inherent in their quantum states. Quantum algorithms, such as Shor's and Grover's algorithms, leverage superposition and entanglement to solve specific problems more efficiently than classical computers.

One of the significant challenges in developing practical quantum computers is decoherence—the loss of quantum coherence due to environmental interactions. Error correction techniques are essential to counteract decoherence and other quantum errors, ensuring reliable quantum computations. The mechanical implementation of quantum computers varies depending on the technology, including trapped ions, superconducting circuits, and photonic qubits, each with its own set of advantages and challenges in achieving scalable, fault-tolerant quantum computers.

Superconducting qubits, a common architecture pursued by leading researchers and companies, operate using superconducting materials (like aluminum or niobium) cooled to near absolute zero (−273.15° C. or 0 Kelvin). The Josephson junction, the fundamental building block of these qubits, comprises two superconducting materials separated by a thin insulating barrier, creating the necessary quantum states. Superconducting qubits achieve superposition by applying microwave pulses, which manipulate the energy levels of the Josephson junction. Coupled using superconducting resonators or waveguides, these qubits interact and perform quantum operations.

The quantum processor, housed within a dilution refrigerator, operates at temperatures just above absolute zero to exploit superconducting properties. Quantum logic gates, such as the Hadamard gate and CNOT gate, manipulate qubits' quantum states through precise microwave pulses, facilitating computation within the quantum circuit. Measurement of qubits collapses their superposition states into classical states, providing computational outputs. Due to the fragile nature of quantum states and decoherence effects, error correction techniques, such as quantum error correction codes, are employed to enhance computation reliability.

Superconducting qubit-based quantum computers encode information in quantum states, with types such as transmon and xmon qubits improving coherence times and reducing noise sensitivity. These qubits are integral to current quantum research, used in quantum processors. Overcoming decoherence involves precise pulse control, purification techniques, and advanced materials engineering to improve coherence times.

Quantum algorithms executed by superconducting qubit-based quantum computers leverage quantum parallelism and entanglement, solving specific problems more efficiently than classical methods. Scaling up the number of qubits and reducing error rates are critical challenges, with ongoing efforts focusing on integrating more qubits into coherent processors and enhancing gate fidelities.

Superconducting qubits, which are at the heart of many quantum computing microprocessors, rely on Josephson junctions. These junctions consist of two superconductors separated by a thin insulating barrier, allowing Cooper pairs (pairs of electrons) to tunnel through the barrier without resistance due to quantum tunneling. This process can be described by the Josephson equations: the first equation relates the current through the junction to the phase difference across it, while the second equation describes the time evolution of the phase difference due to an applied voltage. These equations enable the manipulation of qubit states through applied voltages, effectively controlling the tunneling current.

The discrete energy levels of superconducting qubits, typically the ground state and the first excited state, are manipulated using precise microwave pulses. These pulses, through a process known as Rabi oscillations, allow controlled transitions between the qubit states. The circuits containing these qubits are designed with components like capacitors, inductors, and the Josephson junctions themselves, forming quantum LC circuits that define the qubit's energy levels. The non-linear inductance of the junction is crucial for the qubit's operation.

To read out the qubit states, resonators coupled to the qubits are probed with microwaves, where the state of the qubit affects the resonator's frequency. This dispersive readout technique allows the inference of the qubit state by measuring the reflected microwave signal's phase and amplitude without directly disturbing the qubit. Initialization of qubits involves cooling them to near absolute zero temperatures using dilution refrigerators to minimize thermal noise and ensure high coherence times. A sequence of microwave pulses is then applied to prepare the qubits into desired superpositions or entangled states, with precise control over pulse shape, duration, and frequency being critical.

Quantum gate operations involve single-qubit and two-qubit gates. Single-qubit gates, such as Pauli-X, Y, and Z rotations, are achieved by applying microwave pulses at specific frequencies corresponding to the qubit's transition frequencies. The Hadamard gate, for instance, creates a superposition state by rotating the qubit's state vector halfway around the Bloch sphere. Two-qubit gates, like the Controlled-NOT (CNOT) gate, involve coupling two qubits so that the state of one (the control) affects the state of the other (the target). This is achieved through capacitive or inductive coupling, governed by an interaction Hamiltonian that facilitates entanglement.

State transfer between qubits is facilitated by coupling mechanisms, such as resonators or direct interactions. In architectures like the transmon qubit, qubits are coupled through a shared microwave resonator, allowing coherent information transfer. A quantum bus, which is a shared resonator or transmission line, enables long-range interactions between qubits, making scalable architecture possible by allowing non-adjacent qubits to interact.

At the molecular level, the properties of superconducting materials play a crucial role. Cooper pairs form at low temperatures, creating a superconducting state with zero resistance. Magnetic flux through a superconducting loop is quantized, essential for maintaining stable qubit states. However, interactions with the environment can cause decoherence, leading to the loss of quantum information. Phonon interactions, electromagnetic radiation, and material defects are common sources of decoherence. To mitigate this, quantum error correction techniques, such as the surface code, use multiple physical qubits to represent a single logical qubit, enabling error detection and correction without direct measurement of the qubit states.

Superconducting qubits utilize the unique properties of superconducting materials and Josephson junctions for state creation and manipulation. Microwave pulses control these states, enabling quantum gate operations and coherent state transfer. The coupling of qubits through resonators or direct interactions, along with error correction techniques, forms the basis of powerful quantum processors. This intricate interplay of superconducting circuits, precise control mechanisms, and error correction enables the realization of quantum computing.

To visualize qubit superposition states, imagine the Bloch sphere. The top of the sphere represents the state \(|0\rangle\) (pronounced “ket zero”), and the bottom represents the state \(|1\rangle\) (pronounced “ket one”). Any point on the surface of the sphere represents a possible state of a qubit.

Quantum logic gates are operations that change the state of qubits. The Hadamard gate creates superposition states. When a qubit in the state \(|0\rangle\) passes through a Hadamard gate, it transforms into a state where it has an equal chance of being measured as either \(|0\rangle\) or \(|1\rangle\). Similarly, if the qubit starts in the state \(|1\rangle\) and goes through the Hadamard gate, it also ends up in a balanced superposition. This ability to be in multiple states at once is what gives quantum computers their power, unlike classical bits that can only be in one state at a time (either 0 or 1).

The Hadamard gate is a mathematical operation essential for creating superposition states in quantum computing, represented by a specific 2×2 matrix. Physically, it can be implemented using various technologies. In superconducting qubits, it is achieved through precise microwave pulses, while in trapped ion systems, it uses specific laser pulse sequences. Photonic quantum computers implement the Hadamard gate with beam splitters and phase shifters to control photons. In semiconductor and silicon-based quantum computers, electrical pulses manipulate electron or nuclear spins to realize the gate.

The Pauli-X gate is similar to a classical NOT gate in that it flips the state of a qubit: if the qubit is in the state representing “0,” it changes to “1,” and if it's in the state representing “1,” it changes back to “0.” The CNOT gate, which involves two qubits, is a bit more complex. It flips the second qubit, known as the target qubit, but only if the first qubit, called the control qubit, is in the “1” state. This gate is essential for creating entanglement, a quantum phenomenon where the states of two qubits become interconnected, meaning the state of one qubit directly influences the state of the other.

Beyond these, there are other gates like the Pauli-Y and Pauli-Z, which alter the state of a qubit by rotating it around specific axes on what's known as the Bloch sphere, a way to visualize a qubit's state. These rotations change the qubit's phase, which is crucial for certain quantum operations.

In quantum computation, the process usually begins by setting qubits to a known state, typically “0.” From there, a sequence of quantum gates is applied to manipulate the qubits according to a specific algorithm, allowing the system to perform logical operations while the qubits are in a superposition of states-meaning they can represent multiple possibilities at once. The final step is to measure the qubits, which causes their states to collapse into definite values, and the outcomes of these measurements provide the results of the computation.

For example, if you were to use a quantum computing framework like Qiskit, you′d start by setting up the environment, much like preparing your tools before starting a task. You would then create a quantum circuit that includes one qubit and one classical bit, setting the stage for your computation.

In this circuit, applying a Hadamard gate to the qubit would put it into a superposition, making it equally likely to be in the “0” or “1” state when you measure it. If you then apply a Pauli-X gate, it flips the qubit's state, much like toggling a switch. Finally, when you measure the qubit, its state collapses to either “0” or “1,” and this outcome is recorded in the classical bit.

The quantum circuit is executed on a quantum simulator, which mimics a real quantum computer. The results are collected and visualized, showing the probabilities of the qubit being in each state. This simple operation demonstrates how quantum computers can explore multiple possibilities at once, a key feature that gives them their computational power.

The Hadamard gate's ability to create superposition states is fundamental for quantum computations. It allows qubits to be in multiple states simultaneously, enabling quantum computers to perform many calculations at the same time and use quantum interference to solve complex problems more efficiently than classical computers. Understanding the Hadamard gate helps us appreciate the core principles of quantum computing and its potential to revolutionize technology.

The direction of a qubit state before measurement determines the probabilities of the outcomes. Quantum gates manipulate this direction on the Bloch sphere, and measurement collapses the state into a definite outcome used for computation. To achieve correct logical operations, qubits must be manipulated into the desired state using appropriate quantum gates, often in a sequence, and using gates like CNOT to create entanglement for complex operations.

Various physical systems are used to implement qubits, including superconducting circuits, trapped ions, and quantum dots. Quantum tunneling is particularly relevant in certain types of qubits. In some qubit implementations, such as those based on quantum dots or superconducting circuits, quantum tunneling is a key mechanism that influences qubit behavior and interactions.

Quantum dots confine electrons or holes in a small, semiconductor nanostructure. The ability of electrons to tunnel between dots or through barriers is fundamental to the operation of quantum dot qubits.

In double quantum dot systems, an electron can tunnel between two adjacent dots, and the superposition of these states can be used to represent a qubit.

Superconducting qubits, such as flux qubits and charge qubits, rely on the tunneling of Cooper pairs (pairs of electrons bound together at low temperatures) through Josephson junctions.

Josephson Junctions are thin insulating barriers between two superconductors. Quantum tunneling through these junctions creates a phase difference that can represent qubit states.

Topological qubits use anyons, particles that can exhibit non-abelian statistics, in certain materials. Tunneling between these anyons can create topologically protected states that are robust against local perturbations.

Quantum coherence is the maintenance of quantum superpositions. Quantum tunneling can contribute to both maintaining and disrupting coherence, depending on the context. Uncontrolled tunneling events can cause decoherence, leading to loss of quantum information. Minimizing decoherence is crucial for reliable quantum computations. In systems like quantum dots, controlled tunneling events can be used to implement gate operations.

Tunneling interactions between qubits in close proximity, referred to as Two-Qubit gates, can enable entangling gates. Quantum annealing is a quantum computing approach that leverages quantum tunneling to find the global minimum of an optimization problem.

D-Wave quantum computers use quantum annealing, where tunneling allows the system to explore possible solutions and settle into the lowest-energy state, representing the optimal solution.

Controlling and minimizing unwanted tunneling is needed to maintain a qubit coherence and reduce errors. Techniques include better isolation of qubits and improved materials.

Quantum error correction codes are designed to detect and correct errors, including those caused by unwanted tunneling, to ensure reliable computation. Research into new materials with better tunneling properties or lower noise levels can enhance qubit performance and coherence times. Isolating qubits from environmental noise and using techniques like dynamic decoupling can mitigate the impact of unwanted tunneling and decoherence.

FIG. 3 shows a refrigerator structure 41. The refrigerator is composed of several layers, each corresponding to different temperature stages. The structure is supported by a framework that helps maintain the alignment and stability of the qubits and other critical elements within the refrigerator.

Breaking down how qubits and measurement work in the context of superposition and computation.

### 1. Superposition Before Measurement

When you have 3 qubits, they can exist in a superposition of all possible states simultaneously:

These states are weighted by complex probabilities (amplitudes), which means the overall state of the qubits is a combination like:

Here, are complex numbers, and their squared magnitudes sum to 1 (that represents the probability of measuring each state).

### 2. Measurement

When you measure the qubits, the superposition collapses to one of the 8 possible states (e.g.).
After the measurement, there is no longer access to the superposition; only the known state of system collapsed into.

### 3. How Many “Bits” Are Represented?

Before Measurement: The qubits encode much more than 3 bits of information because they can represent all states simultaneously through superposition.
After Measurement: Each qubit gives a single binary outcome (0 or 1), so measuring 3 qubits gives you 3 classical bits of information, or the like.

### 4. Key Insight: Quantum Algorithms Exploit Superposition

The power of quantum computation comes before the measurement, during the algorithm's operation:
While the qubits are in superposition, quantum gates manipulate them in ways that affect all states at once. This is where the “quantum parallelism” comes into play.
When the algorithm finishes and you measure, it's designed to maximize the likelihood of collapsing the superposition into the correct answer. This process extracts useful information from the exponentially larger quantum state.

### 5. How Many “Logic Pieces” per Qubit?

A single qubit in superposition doesn't directly represent multiple classical bits. However, the system as a whole encodes states where there are a number of qubits. The relationships between the states (via amplitudes and entanglement) are what give quantum computers their power.

With this foundational understanding of how qubits behave and how quantum annealing operates, we now examine how these principles are physically implemented and supported within quantum hardware systems.

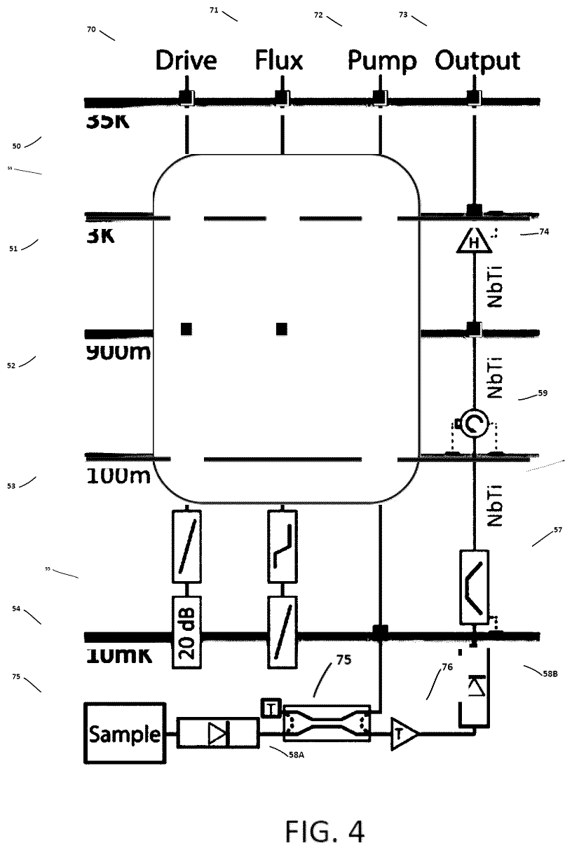

FIG. 4 shows the temperature states within a quantum computer. This figure illustrates the various components and their functions as signals are processed and managed through different levels of cooling temperature stages, ranging from 35K 50, to 3K 51, 900 mK 52, 100 mK 53, down to 10 mK 54. Using the Kelvin temperature scale to millikelvins with the coldest temperature being at the bottom of this diagram where the quantum processor or qubits are located. The signal paths labeled “Drive” 70, “Flux” 71, “Pump” 72 and “Output” 73 correspond to different control and readout signals for the qubits. Various attenuators, filters, and amplifiers are shown to indicate how signals are conditioned to reduce noise and maintain integrity as they pass through these extremely cold environments.

The Drive 70, Flux 71, Pump 72 and Output 73 are the primary signal paths, each with specific functions in controlling and reading out the quantum states of qubits. The attenuators 55 in decibels (db) are placed at various stages to reduce the signal power, which helps in reducing noise that can affect the qubits. Low pass filter 56 and band pass filter 57 are used to allow only specific frequencies to pass, which is crucial for isolating the correct signals and minimizing interference. Isolator(s) 58A and 58B and Circulator(s) 59 are used to protect sensitive components from reflected signals and ensure the correct directionality of the signal flow.

There is a High Electron Mobility Transistor (HEMT) 74 that is used at low temperatures to amplify the signal without introducing significant noise to the quantum computer. Niobium-Titanium (NbTi) wiring is noted, which is a superconducting material often used in quantum computing to ensure minimal resistance and signal degradation.

In operation a sample 75 enters the first isolator 58A. There is a direction coupler 76 that routes the sample 75 into one or more filters 55 or through a 76 traveling-wave parametric amplifier 76 (TWPA) then into the second isolator 58B. After the second isolator 58B the sample then passes through the band pass filter 57 into the circulator 59, the High Electron Mobility Transistor (HEMT) 7 then to the output 73.

### DNA Computing Summary

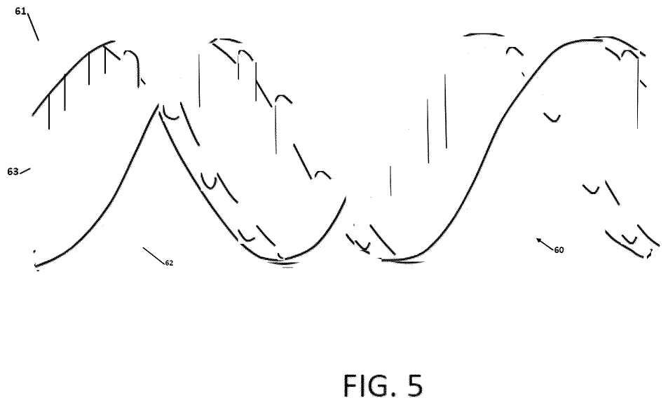

FIG. 5 shows a DNA processing system 60 where DNA computing is a form of computing that uses DNA, biochemistry, and molecular biology hardware, rather than traditional electronic computing. This innovative approach harnesses the natural properties of DNA to perform complex calculations. With an input side 61 and an output side 62.

At its core, DNA computing relies on the ability of DNA molecules to store and process information. DNA is composed of four nucleotides 63: adenine (A), cytosine (C), guanine (G), and thymine (T). These nucleotides pair in specific ways (A with T and C with G) to form the double helix structure of DNA. This pairing property allows DNA to serve as a medium for computation. The four ACGT nucleotides can be used to store data by setting the state of each A, C, G and T nucleotides and placing them sequentially in the DNA strand where the stored data can be read with a DNA reader.

The fundamental unit of information in DNA computing is a DNA strand, which can represent data through its sequence of nucleotides. For instance, a sequence of nucleotides can encode binary information, with different sequences corresponding to different binary values. DNA computing exploits the massive parallelism of molecular interactions, enabling a vast number of operations to be carried out simultaneously.

One of the primary principles in DNA computing is hybridization, where single-stranded DNA molecules with complementary sequences bind to form double-stranded 61 and 62 DNA. This property is used to perform computations by designing DNA strands that represent specific problems and solutions. For example, in a DNA-based computation, different DNA strands can be designed to represent different potential solutions to a problem. Through hybridization and other biochemical reactions, the correct solution can be identified based on the binding patterns of the DNA strands.

DNA computing also utilizes enzymes to manipulate DNA strands. Enzymes like ligases, polymerases, and restriction enzymes can cut, copy, and join DNA sequences, enabling complex operations such as amplification, deletion, and modification of DNA. These biochemical processes are essential for implementing logic operations and algorithms in DNA computing.

One of the significant challenges in DNA computing is error rates due to imperfect biochemical reactions. Errors can arise from incorrect binding of DNA strands, mutations during amplification, and degradation of DNA molecules. To address these issues, error correction techniques are employed, including designing redundant DNA sequences and using enzymes to proofread and repair DNA.

Scaling up DNA computing involves integrating more DNA strands 63 and reactions to solve larger and more complex problems. This requires precise control over the biochemical environment to ensure accurate and reliable computations. Advances in microfluidics and nanotechnology are aiding in the development of scalable DNA computing systems by enabling precise manipulation of small volumes of DNA solutions and reactions.

DNA computing holds promise for various applications, particularly in fields requiring massive parallelism and high-density information storage. Potential applications include cryptography, where DNA computing can be used for secure key generation and encryption, and bioinformatics, where it can assist in analyzing large datasets of genetic information. Additionally, DNA computing can be applied to solve complex optimization problems and model biological systems.

DNA computing leverages the unique properties of DNA molecules and biochemical reactions to perform computations. It offers a novel approach to solving problems beyond the reach of classical computers, with ongoing research focused on overcoming technical challenges and realizing practical DNA-based computing systems.

DNA configured as logic gates enables the construction of DNA-based computational circuits, this includes hybridization and strand displacement through the pairing of complementary DNA strands. For instance, an “input” DNA strand can hybridize with a “template” strand to form a double-stranded DNA.

Strand Displacement occurs when a single-stranded DNA displaces another strand in a DNA duplex. This principle is used to create dynamic interactions between DNA strands, forming the basis of logical operations.

DNA Logic Gates include AND Gates which are designed using two input strands that both need to hybridize with a template strand to produce an output. The output strand is released only when both input strands are present. OR gates are constructed so that either of the two input strands can hybridize with the template strand to produce an output. The output strand is released if at least one of the input strands is present. NOT gates typically involve a strand that prevents an output in the presence of an input strand. For example, an input strand might bind to a template strand and prevent the output strand from being released.

Advanced Logic Gates include NAND, NOR, XOR, and XNOR Gates. These more complex logic gates are created by combining the principles of hybridization and strand displacement in more sophisticated ways. For instance, a NAND gate can be made by combining an AND gate and a NOT gate.

DNA logic gate mechanism directly links to the four nucleotide bases (Adenine (A), Guanine (G), Cytosine (C), and Thymine (T)) through the principles of complementary base pairing, which is the foundation of DNA hybridization and strand displacement. In DNA, the bases pair specifically: Adenine (A) with Thymine (T) and Guanine (G) with Cytosine (C). This specific pairing allows DNA strands to hybridize (bind) to their complementary sequences. Each strand in the DNA logic gate is composed of a sequence of these four bases (A, G, C, T). The sequences are designed so that they will only bind to their complementary sequences according to the rules of base pairing.

An exemplary example of the AGCT Sequences can be understood through the following illustration; the process with specific sequences using A, G, C, and T, Suppose the template strand has the sequence, ‘5′-TTAGCC-3′’ (which we'll denote as ‘T1 B′ A′ T2’ Here, ‘T1’ might be ‘TT’, ‘B′’ might be ‘AG’, ‘A′’ might be ‘CC’, and ‘T2’ might be an extension of the sequence.

Input strand A: ‘5′-GG-3∝’ (complementary to ‘A′’ which is ‘CC’ on the template). Input strand B: ‘5′-CT-3′’ (complementary to ‘B′’ which is ‘AG’ on the template).

Output Strands: Output strand C: ‘5′ . . . 3′’ (initially hybridized to a part of the template that we want to displace).

How AGCT Works in this Context

Hybridization: Input strand A (‘5′-GG-3′’) hybridizes with its complementary sequence on the template strand (‘5′-CC-3′’). A pair with T, and G pairs with C. So, ‘GG’ binds to ‘CC’. Input strand B (‘5′-CT-3′’) hybridizes with its complementary sequence on the template strand (‘5′-AG-3′’). C pairs with G, and T pairs with A. So, ‘CT’ binds to ‘AG’.

When both input strands hybridize with their complementary regions on the template strand, they displace the output strand (which was initially hybridized to the template).

As a visual representation the following steps occur: Template: 5′-TT AG CC-3. Output is-C. After Adding Input Strand A. Template: 5′-TT AG CC-3′. Input A: GG. After Adding Input Strand B: Template: 5′-TT AG CC-3′ Input A: GG. Input B: CT. Strand Displacement: The binding of input strands A and B displaces the output strand C from the template. Template: 5′-TT AG CC-3′
Input A: GG
Input B: CT
(Output C is released).

The process relies on the specific pairing of A with T and G with C. Hybridization and Displacement processes are driven by the thermodynamics of base pairing.

Logic Operations include the presence of both input strands (A and B) is necessary to displace the output strand (C), functioning like an AND gate in logic circuits. In summary, the four bases (A, G, C, T) are integral to the design and function of DNA logic gates, providing the specific interactions needed for the gates to operate through hybridization and strand displacement.

DNA logic gates can be stacked together to form cascade circuits, where the output of one gate becomes the input of another. This stacking allows for the construction of complex computational circuits capable of performing multi-step computations.

DNA Origami and Structural DNA Nanotechnology include several examples including DNA Origami. This technique involves folding a long single-stranded DNA into specific shapes with the help of shorter staple strands. These structures can act as scaffolds for arranging DNA logic gates in a spatially organized manner.

DNA tiles can self-assemble into larger two-dimensional or three-dimensional structures, enabling the construction of complex logic circuits with multiple interconnected gates.

Fluorescent Readouts which include fluorescent markers with associated fluorescent molecules attached to DNA strands can indicate the output of logic gates. When a specific computation is performed, the presence or absence of fluorescence can be detected, providing a visual readout of the computation result.

Another simplified example of a DNA AND Gate includes the following sequence.
Input Strands: A and B.
Template Strand: Contains complementary sequences to both A and B, with a toehold region where hybridization begins.
Output Strand: C, which is initially bound to the template strand.

When both input strands A and B are present, they hybridize with their respective complementary regions on the template strand. This hybridization displaces the output strand C from the template, releasing it into the solution. The release of strand C can be detected, indicating that both inputs A and B were present.

As an example, DNA logic gates can be used in biological systems to control cellular processes, such as gene expression. DNA-based logic circuits can detect specific combinations of biomolecules, aiding in disease diagnosis and personalized medicine. DNA logic gates can enhance the readout processes in DNA-based data storage systems, allowing for more sophisticated data manipulation.

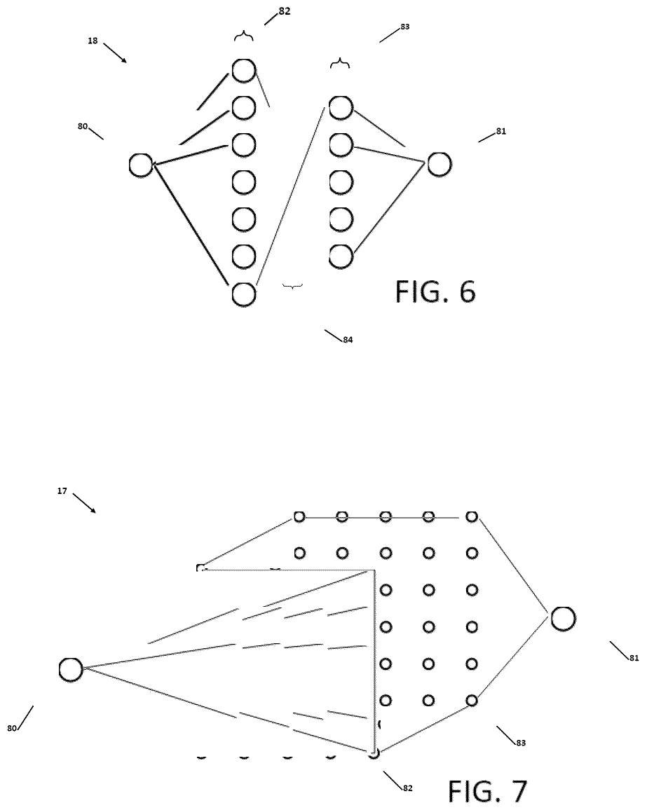

FIG. 6 shows a two-level problem 18 with a problem 80 and a solution 81. In this simplified example it can be a person taking a trip from work 80 to two separate stores and then to home 81. There are multiple driving routes between the two stores 82 and 83 as well as paths to the first store 82 and from the second store 83 to home 81. To identify the quickest time between the two stores 82 and 83 the different paths 84 are routed and may include traffic, and road conditions. This is a simplified case and similar to a choice made by a person commuting on a daily basis.

### Hybrid Quantum DNA Computing

To fully realize a hybrid computational framework, we must now examine the quantum architecture that complements DNA computing-beginning with the cryogenic environment in which quantum processors operate.

Hybrid computational framework input preparation uses classical computing methods to preprocess and encode the input data into formats suitable for both DNA and quantum systems. This includes translating classical data into DNA sequences and initializing qubit states.

Parallel DNA processing employes DNA computing for tasks that benefit from massive parallelism. For instance, use DNA hybridization and enzymatic reactions to perform combinatorial searches or optimization tasks. DNA's natural ability to process large datasets simultaneously can handle the initial stages of complex problem-solving.

Quantum processing transfers the intermediate results from DNA computations to a quantum processor. This step involves translating DNA-encoded solutions into quantum states. Quantum computing can then perform sophisticated operations on these states, taking advantage of quantum parallelism and entanglement.

Integration and communication interfaces and protocols for seamless communication between DNA and quantum systems. Biochemical-to-quantum transducers that can convert molecular states into qubit states and vice versa. Quantum dots or other nanoscale devices could serve as intermediaries.

Hybrid algorithms specifically leverage the strengths of both DNA and quantum computing. For example, use DNA computing for exhaustive searches or generating large solution spaces and quantum computing for refining solutions, optimizing parameters, or solving subproblems that benefit from quantum speedup.

Using both systems to solve the same problem reduces implementing error correction mechanisms for both DNA and quantum processes. DNA computing may require biochemical error correction techniques, while quantum computing relies on quantum error correction codes. Ensure robustness by cross-validating results from both systems.

FIG. 7 shows a multi-dimensional problem with essentially the problem identified in the previous figure. In this three-dimensional figure additional elements are added like purchasing multiple items in two or more stores and routing the person through each store. Other factors such as checking date codes, selecting between multiple packages of similar products with different weights and qualities to identify the quickest (or shortest) path from work 80 to home 81.

Complex optimization problems that require searching for a vast solution space, such as drug discovery or materials design.

Use of DNA computing to generate and evaluate a large number of potential solutions. DNA's massive parallelism allows for the simultaneous processing of numerous candidates.

Quantum-based refinement to transfer promising candidates to a quantum processor. Apply quantum algorithms like Grover's search or variational quantum eigen solver (VQE) to refine these candidates and identify optimal solutions with higher precision.

The interfaces facilitate the transfer of information between DNA and quantum systems. This creates a biochemical process that can be interpreted by quantum devices and vice versa, and hybrid algorithms that maximize the synergy between DNA and quantum computing.

DNA liquid components integrated into microchips, where DNA strands are used to encode and store data. This involves using synthetic DNA sequences that are engineered to represent binary or other data forms. Techniques such as nanopore sequencing or CRISPR-based systems could be used to read and write data to the DNA. These techniques allow precise manipulation of DNA sequences.

Data Transfer is achieved through interfaces that efficiently transfer data between the DNA memory components and the quantum processor. This involves biochemical-to-electronic transducers that convert data from DNA sequences into a form usable by quantum circuits.

Quantum algorithms enhance the efficiency and accuracy of reading from and writing to DNA memory. Quantum-enhanced sensing and error correction improves the reliability of these processes. Benefits include leveraging DNA's storage capacity to significantly increase the data storage capabilities of computing systems. Combining quantum computing's processing power with DNA's storage efficiency leads to faster data processing and retrieval, especially for large datasets. DNA's durability makes it suitable for long-term storage applications, providing a reliable medium for archival purposes.

The system architecture is organized into distinct layers, each with a specialized role. The User Interface (UI) Layer is where end-users interact with the system, submitting problems, viewing results, and monitoring ongoing processes. Beneath this, the Middleware and Orchestration Layer facilitates seamless communication across the different computing paradigms, orchestrating tasks, optimizing resource allocation, and handling errors.

The Classical Computing Layer is dedicated to traditional tasks such as data storage, preprocessing, post-processing, and general-purpose computation. Meanwhile, the Quantum Computing Layer executes quantum algorithms, providing speed-up for tasks related to optimization, cryptography, and simulations. Finally, the DNA Computing Layer handles massive parallel processing, particularly excelling in combinatorial problems and complex pattern matching. Together, these layers create a cohesive and powerful computational environment that leverages the strengths of each paradigm.

The hybrid computational interface incorporates several key components that ensure the system operates efficiently and effectively across its various computing paradigms. The Task Scheduler plays a critical role in this architecture, allocating tasks to the appropriate computing paradigm, be it classical, quantum, or DNA based on the problem's nature, thereby optimizing for speed, accuracy, and resource efficiency. The Data Flow Manager facilitates seamless data transfer between the different layers, handling necessary conversions, such as transforming classical binary data into quantum states or DNA sequences, to ensure compatibility across the paradigms. To maintain system integrity, the Error Correction Module addresses the errors inherent in quantum and DNA computing by leveraging classical computing for redundancy checks and corrections. Lastly, the Optimization Engine continuously monitors overall system performance, dynamically adjusting task distribution in real-time, with the potential use of machine learning to enhance efficiency as the system evolves. Together, these components create a robust framework that supports the complex interactions within the hybrid computational environment.

The hybrid computational interface incorporates several key components that ensure the system operates efficiently and effectively across its various computing paradigms. The Task Scheduler plays a critical role in this architecture, allocating tasks to the appropriate computing paradigm, be it classical, quantum, or DNA, based on the problem's nature, thereby optimizing for speed, accuracy, and resource efficiency. The Data Flow Manager facilitates seamless data transfer between the different layers, handling necessary conversions, such as transforming classical binary data into quantum states or DNA sequences, to ensure compatibility across the paradigms. To maintain system integrity, the Error Correction Module addresses the errors inherent in quantum and DNA computing by leveraging classical computing for redundancy checks and corrections. Lastly, the Optimization Engine continuously monitors overall system performance, dynamically adjusting task distribution in real-time, with the potential use of machine learning to enhance efficiency as the system evolves. Together, these components create a robust framework that supports the complex interactions within the hybrid computational environment.

The Middleware and Orchestration Layer in the hybrid computational interface is essential for coordinating the various computing paradigms, ensuring seamless operation and optimal performance. Within this layer, the Task Scheduler is responsible for Algorithm Classification, which automatically identifies the nature of the problem based on the input and determines whether it is best suited for DNA, quantum, or classical processing. It also handles Resource Allocation, dynamically distributing computational resources according to the system's current load, the complexity of the problem, and user preferences.

The Data Flow Management component ensures smooth interaction between the different computing paradigms. It manages Data Conversion, translating classical data into DNA sequences or quantum states as required, and oversees Parallel Task Management, which coordinates tasks that need to be executed simultaneously across different paradigms, maintaining synchronization and data integrity throughout the process.

Error Correction and Recovery is another important aspect of this layer, employing Quantum Error Correction methods, including quantum error-correcting codes, and leveraging classical computing to detect and rectify errors. Similarly, DNA Error Management monitors the DNA computing processes for issues like strand misalignment or degradation, using classical computing techniques to address and compensate for these errors. Together, these functions enable the Middleware and Orchestration Layer to effectively manage the complex interplay between the classical, quantum, and DNA computing components, ensuring reliable and efficient system performance.

The Computing Paradigm Layers within the hybrid computational interface include the Classical Computing Layer, which plays a crucial role in both preprocessing and post-processing tasks. In the Preprocessing phase, this layer converts raw input data into formats suitable for further processing by the DNA or quantum computing layers. This may involve encoding data specifically for quantum algorithms or translating it into DNA sequences to be used in DNA computing. Once the quantum or DNA computations are complete, the Classical Computing Layer Handles Post-processing, where it gathers the results from these advanced computing paradigms and refines them into clear, usable outputs for the user. This layer ensures that data flows smoothly between the different paradigms and that the results are both accurate and accessible.

The Quantum Computing Layer within the hybrid computational interface is responsible for executing tasks that require quantum processing capabilities. At the core of this layer is Quantum Task Execution, where it runs quantum algorithms such as Grover's algorithm for searching unsorted databases or Shor's algorithm for factoring large numbers, based on the tasks allocated by the system's scheduler. Additionally, this layer is tasked with Entanglement and Superposition Management, which involves creating, maintaining, and manipulating quantum states-ensuring that entanglement and superposition, critical aspects of quantum computation, are accurately preserved and utilized throughout the computational process. This layer is integral to harnessing the unique advantages of quantum computing within the broader hybrid system.

The DNA Computing Layer in the hybrid computational interface is designed to leverage the inherent parallelism of DNA computing for specific types of tasks. Its Parallel Processing capability allows it to efficiently handle tasks that involve exploring large combinatorial spaces, making it ideal for solving problems that benefit from massive parallelism. Additionally, the DNA Computing Layer conducts Molecular Operations, which include essential biochemical processes like annealing, ligation, and amplification. These operations are integral to the computation process, enabling the system to perform complex calculations at the molecular level, thereby extending the computational power and versatility of the overall system.

When a user submits a complex optimization problem, such as finding the optimal route in a large logistics network, the hybrid computational interface seamlessly orchestrates a multi-layered approach to solve it. The system first classifies the problem, recognizing it as well-suited for DNA computing due to its combinatorial nature, and for quantum computing to refine and optimize the solution.

The process begins with the Classical Computing Layer, which preprocesses the input data. It encodes the logistics network into DNA sequences suitable for parallel exploration while simultaneously preparing a quantum circuit that will later be used for optimization. With the problem encoded, the DNA Computing Layer generates all possible routes simultaneously, leveraging its capability for massive parallel processing. These routes, represented as unique DNA sequences, are then converted by the Classical Computing Layer into a format that the Quantum Computing Layer can process.

Next, the Quantum Computing Layer takes the stage, applying an optimization algorithm, such as quantum annealing, to evaluate the possibilities generated by DNA computation. By harnessing quantum parallelism, it quickly identifies the most efficient route. Throughout this process, the Classical Computing Layer monitors the quantum computations for errors, using classical error correction techniques to ensure the accuracy of the results.

Once the quantum computations are complete, the Classical Computing Layer refines the results into a clear and actionable optimized route. The final output is then presented to the user, along with performance metrics and any relevant analysis, providing a comprehensive solution to the complex optimization challenge. This approach illustrates the seamless integration of classical, quantum, and DNA computing, each playing a critical role in solving intricate computational problems.

In one exemplary example, the system's DNA sequences are suspended in a liquid medium within a microfluidic chamber, allowing for precise manipulation and accessibility. The DNA pool acts as a substitute for traditional RAM, providing a high-density, energy-efficient storage layer.

Interfacing directly with this DNA storage is a photonic processor, designed to read and write data at the molecular level. Using advanced photonic techniques, this processor interacts with the DNA sequences through a series of transducers and receivers, which convert electronic signals from the classical computing layer into optical signals that can precisely manipulate DNA molecules. The photonic processor performs rapid data retrieval and writing by exploiting specific wavelengths of light to trigger molecular reactions, enabling swift and accurate data manipulation.

Upon initiation of a computational task, the classical computing layer first preprocesses the data, encoding it into DNA sequences that are stored within the liquid DNA pool. This encoding is optimized for the photonic processor, ensuring that the DNA sequences are ready for fast access when needed.

Once the data is stored, the classical computing layer manages the data flow between the DNA pool and the quantum computing layer. It ensures that data is retrieved from DNA storage with minimal latency, utilizing the photonic processor's ability to quickly read the required sequences and convert them back into a format usable by the quantum processors. This efficient data retrieval allows the quantum computing layer to access large datasets almost instantaneously, enabling it to perform complex computations such as optimization, cryptographic analysis, and large-scale simulations with unprecedented speed.

The quantum computing layer, once it has completed its processing, generates additional data or refined results that need to be stored back in the DNA pool. The classical computing layer coordinates this process, ensuring that the results are accurately encoded into new DNA sequences and written back into the liquid DNA storage for future access or further processing.

Throughout the operation, the classical computing layer also monitors the system's performance, managing any necessary preprocessing or post-processing tasks, and ensuring that the data integrity is maintained at all times. The seamless integration of these three computing paradigms, classical, quantum, and DNA, enables the system to tackle complex computational problems more efficiently than ever before, providing a scalable and powerful solution for a wide range of applications.

This example of hybrid system represents one exemplary method of a computational process where a liquid DNA pool serves as an advanced storage medium, interfaced through a photonic processor to enable fast and efficient data retrieval and manipulation. By combining the strengths of DNA's storage capacity, photonic precision, classical control, and quantum computing's processing power, this architecture delivers a highly effective solution. A deeper integration of quantum and DNA computing is also anticipated where quantum effects are used to manipulate DNA sequences directly, leading to a fusion of quantum and biological information processing.

Artificial Intelligence plays an important role in enhancing both the operational efficiency and reliability of the proposed hybrid computational system by optimizing the overall process and improving error correction mechanisms between the DNA and quantum computing systems managed by the classical computing layer.

In the realm of process optimization, AI is employed to streamline the intricate interactions between DNA-based storage, photonic processor, and quantum computing layer. AI algorithms are designed to predict which data the quantum computing layer will require and preemptively retrieve and prepare this data from the DNA storage. By analyzing usage patterns and task requirements, AI dynamically manages data flow, ensuring that quantum processors have immediate access to necessary information, thereby minimizing latency. Additionally, AI enhances task scheduling and resource allocation by continuously monitoring system performance and workload distribution. It can dynamically adjust how tasks are assigned to the different computing paradigms, making real-time decisions on whether tasks should be handled entirely by quantum computing or if they should first undergo partial processing within the DNA computing layer, depending on efficiency metrics and system load. As the system operates, AI further improves its performance through adaptive learning, where it learns from previous computations, refining its strategies for data encoding, retrieval, and processing. This continuous learning capability allows the system to become more efficient over time, optimizing the overall computation workflow.

On the other hand, AI significantly strengthens error correction, which is vital in a hybrid system that integrates DNA and quantum computing, both of which present unique challenges related to error management. AI is trained to detect anomalies and errors in real-time as data is transferred between the DNA and quantum computing layers. By using machine learning techniques, AI can identify patterns that signify potential errors, such as data degradation in DNA sequences or quantum decoherence and flag these issues before they affect computational outcomes. Moreover, AI predicts when and where errors are likely to arise based on historical data and current system conditions. By analyzing factors like the stability of DNA storage or the susceptibility of quantum states to decoherence, AI can initiate preemptive corrective measures, such as re-encoding DNA sequences or applying error-correcting codes to quantum states before processing. When errors are detected, AI automatically deploys correction protocols tailored to the specific nature of the error. For instance, AI might trigger the re-synthesis of degraded DNA sequences or adjust photonic read/write parameters to correct misalignments, while for quantum errors, AI could apply quantum error correction codes or redistribute the computational workload to minimize the impact of decoherence. AI also continuously monitors the effectiveness of these error correction techniques, learning which strategies are most effective in different scenarios, thereby refining its approach over time. This ongoing improvement enhances the system's overall resilience to errors, reducing the need for manual intervention.

By integrating AI into both process optimization and error correction, the hybrid computational system achieves higher levels of efficiency, reliability, and adaptability. AI-driven process management ensures that the system operates at peak efficiency, with a seamless data flow between the DNA storage, photonic processor, and quantum computing layers. Simultaneously, AI-enhanced error correction provides robust safeguards against the inherent challenges of managing complex, sensitive computations across multiple paradigms. This dual application of AI not only maximizes the system's computational power but also ensures the accuracy and reliability of its output.

By combining the strengths of DNA and quantum computing, a powerful hybrid computational paradigm capable of tackling complex problems more efficiently than either technology alone. This approach not only leverages the massive parallelism of DNA computing and quantum speedup but also opens new avenues for innovative research and practical applications. Along with the Hybrid Quantum/DNA computing process described in great detail, it is also anticipated to integrate the following computing processes to enhance both the Quantum and DNA hybrids, utilizing the error correction process described; Neuromorphic computing could handle tasks related to learning, adaptation, and pattern recognition, which are challenging for classical systems. This could lead to systems that not only solve problems but also learn and adapt in real-time, making the overall system more autonomous and intelligent.

Integrating optical computing with the existing hybrid could lead to faster data transmission and processing speeds. This system could take advantage of optical computing for tasks that require rapid data processing and parallelism, further enhancing the system's overall speed and efficiency.

Integrating topological quantum computing into the hybrid system significantly reduces errors and increases the stability of quantum computations. This would make the quantum component of the hybrid system much more powerful and reliable.

Incorporating protein computing into the hybrid system will allow for highly specialized biological computations, complementing the broader parallelism of DNA computing with specific molecular-level tasks. This fusion enables unprecedented computational capabilities, such as using quantum mechanics to directly influence biological processes at the molecular level, leading to breakthroughs in both computation and biotechnology.

Integrating brain-computer interfaces allows for direct human input into complex problem-solving processes, enabling a hybrid system where human intuition and creativity complement the raw computational power of the machine. This could be particularly powerful in creative fields, complex decision-making, and personalized medicine.

Quantum computers have promising applications across various fields, including cryptography, optimization, and material science. For instance, Shor's algorithm can break classical encryption, quantum annealing can solve complex optimization problems, and quantum simulations can explore new materials for electronics, energy, and pharmaceuticals.

In one exemplary embodiment of the hybrid computing system, a DNA-based microfluidic processing unit (MPU) chip is integrated to leverage the parallelism of DNA computing while interacting dynamically with classical and quantum computing processes. This DNA-based MPU employs programmable Boolean logic gates (AND, OR, and NOT) to perform complex calculations using cascaded reactions within microfluidic channels. The process begins with the binary computing system preprocessing the input data and encoding it into DNA strands. These strands are introduced into the MPU, where they interact with logic template DNA molecules in controlled microfluidic environments. By operating automated valve switches and leveraging servo motors for precise control, the MPU executes sequential and combinational logic operations.

For example, a problem requiring Boolean calculations is divided into subproblems by the binary computing system, which then distributes specific operations to the DNA MPU. The AND, OR, and NOT gates within the MPU use cascaded reactions to execute the operations, with fluorescence-based feedback providing real-time monitoring of reaction states. Outputs from these DNA computations, validated by the fluorescence intensity and pattern, are fed back to the binary computing system for integration with classical computational results or forwarded to the quantum processing system for further optimization. This dynamic flow ensures that the DNA computations are error-checked and seamlessly contribute to the overall hybrid process.

The microfluidic chip's programmability is particularly advantageous in hybrid computing, as it allows iterative computations and supports cascading operations such as XOR and multiplexer functions. For instance, the MPU can execute a 2-to-1 multiplexer operation by combining AND and OR gates in a three-step cascade. Fluorescent markers embedded within the DNA molecules illuminate successful reactions, enabling the binary computing system to interpret the results accurately. In scenarios where errors or incomplete reactions occur, the binary system triggers re-computation within the MPU or escalates the issue to the quantum processor for probabilistic resolution.

As the DNA MPU operates, the classical computing system functions as a controller, managing the interaction between the DNA gates and the quantum subsystem. It preprocesses data, directs computations to the MPU, and aggregates results for downstream processing. The quantum processor enhances this hybrid framework by accelerating tasks such as combinatorial searches or optimization problems that benefit from quantum parallelism. In such cases, DNA computation provides the initial broad solution set, and the quantum processor refines it for optimal results.

This integration of the DNA-based MPU chip into the hybrid computing framework highlights its ability to handle complex logic operations at a molecular level. By incorporating programmable DNA logic gates and fluorescence-based validation, the system achieves robust error correction and scalable performance. Furthermore, the seamless interaction between the DNA MPU, classical binary computing, and quantum processing unlocks new possibilities for tackling computational challenges in fields like genetic analysis, data storage, and artificial intelligence. This dynamic interplay exemplifies the transformative potential of hybrid systems in harnessing the strengths of DNA and quantum computing within a unified architecture.

This code demonstrates a hybrid computational system that integrates DNA-based logic operations, classical computing, and quantum computing to solve complex problems efficiently. It begins by encoding binary inputs as DNA sequences, which are then processed using DNA templates (AND, OR, NOT) in microfluidic reaction chambers to perform logical operations. The results of these operations are analyzed through fluorescence detection to generate binary data. This binary output is then passed to a classical computing system, which validates or further processes the results. If the classical system cannot fully resolve the computation, the process transitions to a quantum computing phase, where Grover's algorithm is employed to efficiently search for a specific solution (such as a marked binary string) among a reduced candidate space. By leveraging the parallelism of DNA computing, the reliability of classical processing, and the speedup of quantum algorithms, the system is capable of solving problems that are computationally intensive or infeasible with a single paradigm.

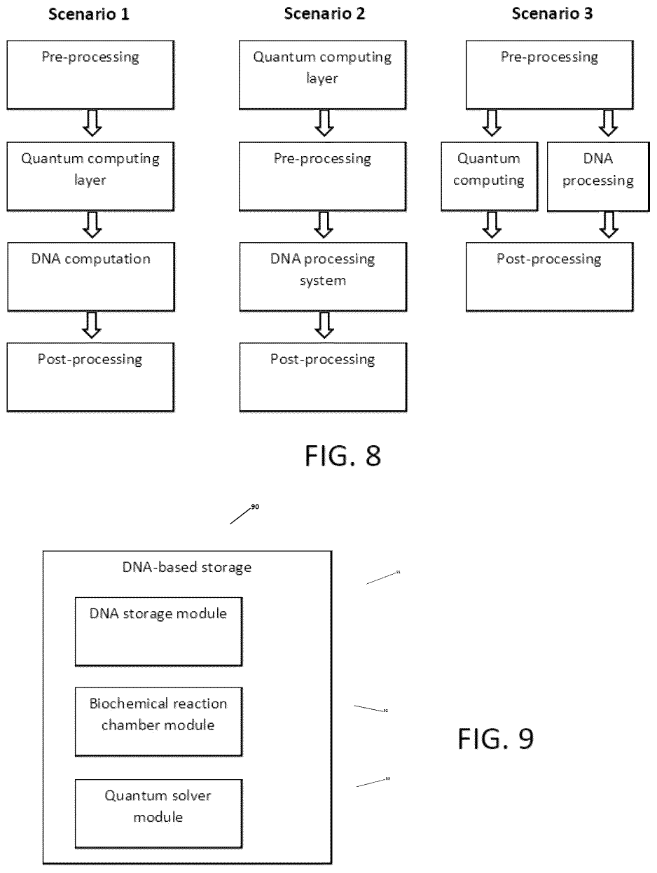

While the described system typically utilizes DNA computing to perform broad parallel exploration before quantum refinement, alternative embodiments may reverse or modify this sequence. FIG. 8 shows three different scenarios for configuring the hybrid computer processing. In Scenario 1, the quantum computing layer may be employed ‘prior to DNA computation’ to perform probabilistic filtering or constraint-based reduction of the problem space. This allows the DNA computing layer to focus only on a refined subset of potential solutions, improving efficiency and reducing biochemical resource usage.

In another embodiment, Scenario 2, the quantum computer may even precede the classical preprocessing layer, where it acts as an initial optimizer or entropy analyzer-using quantum randomness or amplitude amplification to guide how the classical layer encodes data for DNA or quantum tasks. These alternative sequencing options demonstrate the system's flexibility and modularity, enabling dynamic orchestration based on the specific nature of the problem or the real-time availability of computing resources.

In one embodiment, Scenario 3, a hybrid computing system is provided that integrates DNA-based logic processing, biological storage, and quantum circuit optimization. The system may be modularly constructed from at least three components: (1) a DNA storage module, (2) a reaction chamber module, and (3) a quantum solver module.

DNA Storage Module: The DNA storage module includes means for encoding binary data into DNA nucleotide sequences using an error-correction scheme. In some embodiments, the encoding process employs parity-based or Hamming(7,4) error correction.

Binary digits (bits) are converted to fixed-length nucleotide groups. In one implementation, a bit value of ‘0’ is encoded as the nucleotide sequence “ATCG”, and a bit value of ‘1’ as “GCAT”. The encoded sequence may be duplicated a plurality of times to implement redundancy.

Upon decoding, the nucleotide sequence is parsed into discrete groups and translated back into binary form using a reverse mapping. Error checking is performed based on the encoded error correction scheme. Invalid sequences may be flagged or rejected depending on detected parity or Hamming inconsistencies.

Reaction Chamber Module: The reaction chamber module simulates DNA-based logic operations by comparing input sequences against predefined logic templates. Templates may correspond to logical operations such as AND, OR, XOR, NAND, or NOR.

Each template includes a nucleotide sequence and a threshold parameter. A scoring function evaluates the similarity between the template and each input, which may be based on the number of matched nucleotides, enzyme efficiency, or thermal conditions.

The reaction proceeds in discrete time steps. At each step, a fluorescence intensity value is computed, optionally incorporating Gaussian or Poisson-distributed noise. If the average intensity across input comparisons meets or exceeds the defined threshold, the reaction is considered successful.

Reacting results may be output as a success/failure flag, a fluorescence score, or both.

Quantum Solver Module: The quantum solver module utilizes a quantum circuit simulator to identify optimal binary sequences from a candidate set. The circuit is initialized with a superposition of all possible states, and variational gates are applied using, for example, an EfficientSU2 ansatz with linear entanglement.

Noisy simulation is optionally applied using a composite noise model, which may include depolarizing and thermal relaxation errors.

The quantum circuit is executed a plurality of times (“shots”), and results are collected as a frequency distribution over output states. The state with the highest normalized frequency is selected as the optimal candidate. Optionally, the overlap (probability) associated with the selected state may be retained or displayed.

System Execution: The hybrid system may be configured to perform parallel execution of DNA reactions and quantum optimization.

In operation, two or more binary inputs are encoded into DNA sequences and stored. Logic operations are applied to DNA inputs using the reaction chamber module in parallel threads. Simultaneously or subsequently, the quantum solver module evaluates candidate binary sequences to identify the closest match to a specified target.

The system outputs may include a list of successful logic operations, reaction scores, selected quantum states, and associated probabilities.

Variations and Alternative Embodiments: Alternative error correction methods may be employed, including Reed-Solomon, CRC, or custom parity codes.

DNA-to-binary mappings may be user-defined and extend beyond 4-nucleotide groupings.
Logic templates may be dynamically adjusted based on environmental inputs or enzyme parameters.
Quantum circuits may use alternative ansätze or optimization routines.
Execution order may be sequential or fully parallel depending on application.

The following is an exemplary implementation of the described hybrid computing system provided in Python. This code is non-limiting and serves to demonstrate one possible embodiment of the hybrid computing process. Variants in language, structure, or platform are anticipated and fall within the scope of the present disclosure:

Code example:

```
  import random
  import numpy as np
  import matplotlib.pyplot as plt
  from qiskit import Aer, QuantumCircuit, execute
  from qiskit.providers.aer.noise import NoiseModel, depolarizing_error,
  thermal_relaxation_error
  from qiskit.circuit.library import EfficientSU2
  from concurrent.futures import ThreadPoolExecutor
  # Enhanced DNA Storage
  class DNAStorage:
    def _{——}init_{——}(self):
      self.storage = { }
      self.dna_mapping = {“0”: “ATCG”, “1”: “GCAT”} # Configurable mapping
    def encode_with_parity(self, binary_sequence):
      “““
      Simple parity error correction.
      ”””
      parity = str(binary_sequence.count(“1”) % 2)
      return binary_sequence + parity
    def encode_with_hamming(self, binary_sequence):
      “““
      Apply Hamming(7,4) error correction.
      ”””
      data_bits = [int(bit) for bit in binary_sequence]
      parity_bits = [
        data_bits[0] \hat{ } data_bits[1] \hat{ } data_bits[3],
        data_bits[0] \hat{ } data_bits[2] \hat{ } data_bits[3],
        data_bits[1] \hat{ } data_bits[2] \hat{ } data_bits[3],
      ]
      return “”.join(map(str, data_bits + parity_bits))
    def load(self, input_name, binary_sequence, method=“hamming”,
  redundancy_factor=2):
      “““
      Encode binary data with chosen error correction method and redundancy.
      ”””
      if method == “hamming”:
        binary_sequence = self.encode_with_hamming(binary_sequence)
      elif method == “parity”:
        binary_sequence = self.encode_with_parity(binary_sequence)
      else:
        raise ValueError(“Invalid encoding method. Choose ‘hamming’ or
‘parity’.”)
      dna_sequence = “”.join(self.dna_mapping[bit] for bit in binary_sequence)
      redundant_sequence = dna_sequence * redundancy_factor
      print(f“Loaded DNA for {input_name} (with redundancy and {method} error
correction): {redundant_sequence}”)
      self.storage[input_name] = redundant_sequence
    def decode(self, dna_sequence, method=“hamming”):
      “““
      Decode DNA sequence and validate with the chosen error correction
method.
      ”””
      reverse_mapping = {v: k for k, v in self.dna_mapping.items( )}
      binary_sequence = “”.join(reverse_mapping[dna_sequence[i:i+4]] for i in
range(0, len(dna_sequence), 4))
      if method == “hamming”:
        data, parity = binary_sequence[:4], binary_sequence[4:]
        if not self.validate_hamming(data, parity):
          raise ValueError(“Error detected in DNA sequence using Hamming
validation.”)
      elif method == “parity”:
        data, parity = binary_sequence[:−1], binary_sequence[−1]
        if data.count(“1”) % 2 != int(parity):
          raise ValueError(“Error detected in DNA sequence using parity
validation.”)
      else:
        raise ValueError(“Invalid decoding method. Choose ‘hamming’ or
‘parity’.”)
      return data
    @staticmethod
    def validate_hamming(data, parity):
      “““
      Validate Hamming(7,4) error correction.
      ”””
      data_bits = [int(bit) for bit in data]
      parity_bits = [int(bit) for bit in parity]
      calculated_parity = [
        data_bits[0] \hat{ } data_bits[1] \hat{ } data_bits[3],
        data_bits[0] \hat{ } data_bits[2] \hat{ } data_bits[3],
        data_bits[1] \hat{ } data_bits[2] \hat{ } data_bits[3],
      ]
      return calculated_parity == parity_bits
  # Enhanced Reaction Chamber
  class ReactionChamber:
    def _{——}init_{——}(self):
      self.templates = {
        “AND”: {“template”: “ATCGATCG”, “threshold”: 0.75},
        “OR”: {“template”: “GCATGCAT”, “threshold”: 0.5},
        “XOR”: {“template”: “TAGCTAGC”, “threshold”: 0.6},
        “NAND”: {“template”: “CTAGCTAG”, “threshold”: 0.85},
        “NOR”: {“template”: “GCTAAGCT”, “threshold”: 0.7},
      }
    def calculate_reaction_kinetics(self, seq1, seq2, enzyme_efficiency):
      matches = sum(1 for a, b in zip(seq1, seq2) if a == b)
      return enzyme_efficiency * (matches / len(seq1))
    def run_reaction(self, input1, input2, operation, temperature=37,
enzyme_efficiency=0.9, adaptive_threshold=None):
      if len(input1) != len(input2):
        raise ValueError(“Input sequences must be of the same length!”)
      if operation not in self.templates:
        raise ValueError(f“Invalid operation: {operation}. Supported operations:
{list(self.templates.keys( ))}”)
      operation_data = self.templates[operation]
      template = operation_data[“template”]
      threshold = adaptive_threshold(temperature, enzyme_efficiency) if
adaptive_threshold else operation_data [“threshold”]
      match_score_1 = self.calculate_reaction_kinetics(input1, template,
enzyme_efficiency)
      match_score_2 = self.calculate_reaction_kinetics(input2, template,
enzyme_efficiency)
      average_score = (match_score_1 + match_score_2) / 2
      fluorescence = [ ]
      for step in range(20):
        noise = (np.random.normal(0, 0.02) if step % 2 == 0 else
np.random.poisson(lam=0.02)) * (temperature / 37.0)
        fluorescence_intensity = max(0, average_score + noise)
        fluorescence.append(fluorescence_intensity)
        if fluorescence_intensity >= threshold:
          print(f“Threshold reached at step {step}. Reaction successful.”)
          Break
      plt.figure(figsize=(8, 6))
      plt.plot(fluorescence, marker=“o”, label=“Fluorescence Intensity”)
      plt.axhline(y=threshold, color=“r”, linestyle=“--”, label=“Threshold”)
      plt.title(f“{operation} Reaction Fluorescence at {temperature}°C”)
      plt.xlabel(“Time Step”)
      plt.ylabel(“Fluorescence Intensity”)
      plt.legend( )
      plt.grid(True)
      plt.show( )
      final_fluorescence = sum(fluorescence) / len(fluorescence)
      return final_fluorescence > threshold, final_fluorescence
  # Enhanced Quantum Solver
  class QuantumSolver:
    def _{——}init_{——}(self):
      self.backend = Aer.get_backend(“qasm_simulator”)
      self.noise_model = self.create_noise_model( )
    def create_noise_model(self):
      noise_model = NoiseModel( )
      dep_error = depolarizing_error(0.01, 1)
      thermal_error = thermal_relaxation_error(0.02, 0.1, 1)
      noise_model.add_all_qubit_quantum_error(dep_error, [“u3”, “cx”])
      noise_model.add_all_qubit_quantum_error(thermal_error, [“u3”, “cx”])
      return noise_model
    def optimize_candidates(self, candidates, target_state):
      n = len(candidates[0])
      qc = QuantumCircuit(n)
      for i in range(n):
        qc.h(i)
      qc.compose(EfficientSU2(n, entanglement=“linear”), inplace=True)
      qc.measure_all( )
      try:
        job = execute(qc, self.backend, noise_model=self.noise_model,
shots=2048)
        counts = job.result( ).get_counts( )
      except Exception as e:
        print(f“Quantum execution failed: {e}”)
        print(“Retrying with fewer shots...”)
        try:
          job = execute(qc, self.backend, noise_model=self.noise_model,
shots=1024)
          counts = job.result( ).get_counts( )
        except Exception as retry_error:
          print(f“Retry failed: {retry_error}”)
          return None
      mitigated_counts = {state: count / sum(counts.values( )) for state, count in
counts.items( )}
      best_candidate = max(mitigated_counts, key=mitigated_counts.get)
      overlap = mitigated_counts[best_candidate]
      plt.figure(figsize=(10, 6))
      plt.bar(mitigated_counts.keys( ), mitigated_counts.values( ), color=“blue”,
alpha=0.7)
      plt.title(“Quantum Candidate Overlap”)
      plt.xlabel(“Candidate States”)
      plt.ylabel(“Overlap Probability”)
      plt.grid(axis=“y”)
      plt.show( )
      return {“state”: best_candidate, “overlap”: overlap}
  # Hybrid System
  class HybridSystem:
    def _{——}init_{——}(self, dna_storage=None, reaction_chamber=None,
quantum_solver=None):
      self.dna_storage = dna_storage or DNAStorage( )
      self.reaction_chamber = reaction_chamber or ReactionChamber( )
      self.quantum_solver = quantum_solver or QuantumSolver( )
    def execute_parallel(self, inputs, operations, target_state):
      def process_operation(operation):
        input1 = self.dna_storage.storage[“input1”]
        input2 = self.dna_storage.storage[“input2”]
        return self.reaction_chamber.run_reaction(input1, input2, operation)
      print(“Starting Hybrid System Execution...”)
      # Load inputs
      for input_name, binary_sequence in inputs.items( ):
        self.dna_storage.load(input_name, binary_sequence)
      # Parallelize DNA logic operations
      print(“\nPerforming DNA Computation...”)
      with ThreadPoolExecutor( ) as executor:
        dna_results = list(executor.map(process_operation, operations))
      # Quantum optimization
      print(“\nPerforming Quantum Optimization...”)
      valid_candidates = [“10101010”, “11001100”, “11101110”, “10011001”]
      quantum_result =
self.quantum_solver.optimize_candidates(valid_candidates, target_state)
      return {“dna_results”: dna_results, “quantum_result”: quantum_result}
  # Example Usage
  if _{——}name_{——} == “_{——}main_{——}”:
    inputs = {
      “input1”: “10101010”,
      “input2”: “11001100”,
    }
    operations = [“AND”, “XOR”, “NAND”]
    target_state = “11001100”
    hybrid_system = HybridSystem( )
    final_solution = hybrid_system.execute_parallel(inputs, operations,
target_state)
    print(“\nFinal Solution:”, final_solution)
```

FIG. 9 shows another embodiment of a hybrid computational system is provided that integrates DNA-based storage 90 and reaction processing with quantum-enhanced optimization utilizing variational quantum algorithms. The system may comprise at least three subsystems: (1) a DNA storage module 91, (2) a biochemical reaction chamber module 92, and (3) a quantum solver module 93 configured to operate on a noisy quantum backend with classical interface support.

DNA Storage Module 91: The DNA storage module includes functionality to encode binary sequences into nucleotide strings using selectable error correction mechanisms, including Hamming(7,4) codes and parity bit schemes. Each binary digit may be represented by a predetermined nucleotide sequence, such as “ATCG” for ‘0’ and “GCAT” for ‘1’, though alternative mappings may be used.

The encoded sequence may be optionally duplicated to implement a redundancy factor. A decoding routine converts the DNA sequence back into a binary string and verifies the integrity of the data using the corresponding error-checking logic.

Reaction Chamber Module 92: The biochemical reaction chamber is configured to simulate logic gate functionality through sequence-template matching. Each logical operation (e.g., AND, OR, XOR, NAND, NOR) is associated with a predefined DNA template sequence and a fluorescence intensity threshold.

A scoring algorithm compares two input sequences against the operation's template to determine reaction success, with kinetic intensity computed as a function of nucleotide match percentage and enzyme efficiency. Noise modeling may be introduced through Gaussian distributions, and reactions are observed over multiple discrete time steps. A reaction is considered successful when the resulting fluorescence exceeds the operation's threshold.

Quantum Solver Module 93: The quantum solver module includes a backend interface to a quantum simulator. In one embodiment, the system uses IBM's Qiskit framework with access to Aer's ‘qasm_simulator’. A noise model is constructed using a combination of depolarizing and thermal relaxation errors, which are injected into selected gate operations such as U3 and CX.

The module may further leverage high-level quantum optimization algorithms such as the Variational Quantum Eigensolver (VQE) or Quantum Approximate Optimization Algorithm (QAOA) to process candidate states for optimization tasks. These quantum algorithms are optionally executed using Qiskit's ‘QuantumInstance’, which allows integration of noise models and runtime configuration.

The solver is designed to support a hybrid workflow in which candidate binary states are evaluated against a target state to identify the optimal solution based on circuit response and statistical overlap. Though not shown, the optimization process may return to a ranked list of states with associated probability scores.

System Workflow: The hybrid system may operate in a multi-threaded or asynchronous configuration. Input data is loaded into the DNA storage module, error-corrected, and prepared for processing. Logical operations are executed via the reaction chamber. In parallel or subsequently, the quantum solver evaluates optimization tasks based on a defined target state and a list of candidate solutions.

Variations and Alternative Embodiments include the following:
Quantum solvers may use alternative quantum algorithms, such as Grover's or quantum neural networks.
DNA logic templates and thresholds may be dynamically adapted based on environmental variables or reaction history.
Additional logic gates (e.g., XNOR, Majority, Half-Adder) may be defined and included.
Error models for the quantum system may be tailored by backend or gate set.
Candidate evaluation may incorporate classical filtering prior to quantum execution.

Illustrative Implementation: The following Python code provides an exemplary implementation of the described system, using Qiskit, NumPy, and Matplotlib. The code is presented for illustrative purposes only and does not limit the scope of the hybrid computing process.

Code example:

```
  import random
  import numpy as np
  import matplotlib.pyplot as plt
  from qiskit import Aer, QuantumCircuit, execute
  from qiskit.providers.aer.noise import NoiseModel, depolarizing_error,
  thermal_relaxation_error
  from qiskit.circuit.library import EfficientSU2
  from qiskit.algorithms import VQE, QAOA
  from qiskit.opflow import Z, X, I, PauliSumOp
  from qiskit.utils import QuantumInstance
  from concurrent.futures import ThreadPoolExecutor
  # DNA Storage System
  class DNAStorage:
    def _{——}init_{——}(self):
      self.storage = { }
      self.dna_mapping = {″0″: ″ATCG″, ″1″: ″GCAT″} # Configurable mapping
    def encode_with_parity(self, binary_sequence):
      ″″″Simple parity error correction.″″″
      parity = str(binary_sequence.count(″1″) % 2)
      return binary_sequence + parity
    def encode_with_hamming(self, binary_sequence):
      ″″″Apply Hamming(7,4) error correction.″″”
      data_bits = [int(bit) for bit in binary_sequence]
      parity_bits = [
        data_bits[0] \hat{ } data_bits[1] \hat{ } data_bits[3],
        data_bits[0] \hat{ } data_bits[2] \hat{ } data_bits[3],
        data_bits[1] \hat{ } data_bits[2] \hat{ } data_bits[3],
      ]
      return ″″.join(map(str, data_bits + parity_bits))
    def load(self, input_name, binary_sequence, method=″hamming″,
redundancy_factor=2):
      ″″″Encode binary data with chosen error correction method and
redundancy.″″″
      if method == ″hamming″:
        binary_sequence = self.encode_with_hamming(binary_sequence)
      elif method == ″parity″:
        binary_sequence = self.encode_with_parity(binary_sequence)
      else:
        raise ValueError(″Invalid encoding method. Choose ′hamming′ or
′parity′.″)
      dna_sequence = ″″.join(self.dna_mapping[bit] for bit in binary_sequence)
      redundant_sequence = dna_sequence * redundancy_factor
      print(f″Loaded DNA for {input_name} (with redundancy and {method} error
correction): {redundant_sequence}″)
      self.storage[input_name] = redundant_sequence
    def decode(self, dna_sequence, method=″hamming″):
      ″″″Decode DNA sequence and validate with the chosen error correction
method,″″″
      reverse_mapping = {v: k for k, v in self.dna_mapping.items( )}
      binary_sequence = ″″.join(reverse_mapping[dna_sequence[i:i+4]] for i in
range(0, len(dna_sequence), 4))
      if method == ″hamming″:
        data, parity = binary_sequence[:4], binary_sequence[4:]
        if not self.validate_hamming(data, parity):
          raise ValueError(″Error detected in DNA sequence using Hamming
validation.″)
      elif method == ″parity″:
        data, parity = binary_sequence[:−1], binary_sequence[−1]
        if data.count(″1″) % 2 != int(parity):
          raise ValueError(″Error detected in DNA sequence using parity
validation.″)
      else:
        raise ValueError(″Invalid decoding method. Choose ′hamming′ or
′parity′.″)
      return data
    @staticmethod
    def validate_hamming(data, parity):
      ″″″Validate Hamming(7,4) error correction.″″″
      data_bits = [int(bit) for bit in data]
      parity_bits = [int(bit) for bit in parity]
      calculated_parity = [
        data_bits[0] \hat{ } data_bits[1] \hat{ } data_bits[3],
        data_bits[0] \hat{ } data_bits[2] \hat{ } data_bits[3],
        data_bits[1] \hat{ } data_bits[2] \hat{ } data_bits[3],
      ]
      return calculated_parity == parity_bits
  # Reaction Chamber
  class ReactionChamber:
    def _{——}init_{——}(self):
      self.templates = {
        ″AND″: {″template″: ″ATCGATCG″, ″threshold″: 0.75},
        ″OR″: {″template″: ″GCATGCAT″, ″threshold″: 0.5},
        ″XOR″: {″template″: ″TAGCTAGC″, ″threshold″: 0.6},
        ″NAND″: {″template″: ″CTAGCTAG″, ″threshold″: 0.85},
        ″NOR″: {″template″: ″GCTAAGCT″, ″threshold″: 0.7},
      }
    def calculate_reaction_kinetics(self, seq1, seq2, enzyme_efficiency):
      matches = sum(1 for a, b in zip(seq1, seq2) if a == b)
      return enzyme_efficiency * (matches / len(seq1))
    def run_reaction(self, input1, input2, operation, temperature=37,
enzyme_efficiency=0.9, adaptive_threshold=None):
      if len(input1) != len(input2):
        raise ValueError(″Input sequences must be of the same length!″)
      if operation not in self.templates:
        raise ValueError(f″Invalid operation: {operation}. Supported operations:
{list(self.templates.keys( ))}″)
      operation_data = self.templates[operation]
      template = operation_data[″template″]
      threshold = adaptive_threshold(temperature, enzyme_efficiency) if
adaptive_threshold else operation_data[″threshold″]
      match_score_1 = self.calculate_reaction_kinetics(input1, template,
enzyme_efficiency)
      match_score_2 = self.calculate_reaction_kinetics(input2, template,
enzyme_efficiency)
      average_score = (match_score_1 + match_score_2) / 2
      flouresence = [ ]
      for step in range(20):
        noise = np.random.normal(0, 0.02) * (temperature / 37.0)
        fluorescence_intensity = max(0, average_score + noise)
        flourescence.append(flourescence_intensity)
        if flourescence_intensity >= threshold:
          print(f″Threshold reached at step {step}. Reaction successful.″)
          Break
      plt.figure(figsize=(8, 6))
      plt.plot(flourescence, marker=″o″, label=″Flourescence Intensity″)
      plt.axhline(y=threshold, color=″r″, linestyle=″--″, label=″Threshold″)
      plt.title(f″{operation} Reaction Flourescence at {temperature}°C″)
      plt.xlabel(″Time Step″)
      plt.ylabel(″Flourescence Intensity″)
      plt.legend( )
      plt.grid(True)
      plt.show( )
      final_flourescence = sum(flourescence) / len(flourescence)
      return final_fluorescence > threshold, final_flourescence
  # Quantum Solver with Enhanced Features
  class QuantumSolver:
    def _{——}init_{——}(self)
      self.backend = Aer.get_backend(″qasm_simulator″)
      self.noise_model = self.create_noise_model( )
      self.quantum_instance = QuantumInstance(self.backend,
noise_model=self.noise_model, shots=2048)
    def create_noise_model(self):
      noise_model = NoiseModel( )
      dep_error = depolarizing_error(0.01, 1)
      thermal_error = thermal_relaxation_error(0.02, 0.1, 1)
      noise_model.add_all_qubit_quantum_error(dep_error, [″u3″, ″cx″])
      noise_model.add_all_qubit_quantum_error(thermal_error, [″u3″, ″cx″])
      return noise_model
    def optomize_candidates(self, candidates, target_state):
      # Implement a hybrid quantum-classical workflow
      pass # Complete the workflow with quantum-assisted hybrid computation.
```

In another embodiment, it is anticipated to utilize the integration of advanced DNA computing substrates that combine ultra-dense data storage with active, in-place computation. This approach leverages polymer-stabilized DNA structures—such as dendricolloidal scaffolds—that hold DNA molecules in a durable and high-surface-area matrix. These scaffolds allow for non-destructive, high-density storage while enabling enzymatic processes to perform logic operations directly on the DNA strands. Enzymes act as molecular logic gates, manipulating DNA sequences in response to specific inputs, allowing the system to execute combinatorial logic, optimization routines, and iterative functions within the same physical substrate that stores the data. DNA stored in these structures can be rewritten, erased, or recomputed without degradation, enabling dynamic reprogramming similar to electronic memory systems. This embodiment enhances the role of DNA in the hybrid system, transforming it from a passive molecular memory into a living compute substrate, capable of both holding and processing information in tandem. When integrated into the broader hybrid framework alongside quantum refinement, classical orchestration, and AI-led optimization, this architecture represents a fully adaptive, multi-layered computation engine-bridging biology, physics, and machine logic into a unified platform.

It is also anticipated, in further embodiments, that the hybrid system will incorporate additional computational modalities to extend its capability, adaptability, and domain reach. Integrating optical computing into architecture will allow for ultra-fast data transmission and massive parallelism, enabling real-time feedback loops, photonic logic operations, and high-throughput data handling that complements both quantum and classical systems.

Topological quantum computing is expected to be integrated as well, significantly enhancing fault tolerance and quantum coherence by encoding information in topological states, thereby stabilizing quantum operations and increasing the reliability of the system's most sensitive components.

In addition, it is anticipated that the hybrid system will utilize the incorporation of protein-based computing, where protein structures serve as logic mechanisms or programmable biological elements, enabling molecular-level computation that complements DNA's broad-scale parallelism with precision and specialization.

Brain-computer interfaces (BCIs) may also be integrated to establish a direct conduit between human cognition and the hybrid system, allowing intuitive problem formulation, real-time adaptive tuning, and creative logic that bridges the boundary between human insight and machine processing.

Analogue computing is anticipated in certain substructures of the architecture to capture and process continuous signals, ideal for simulating natural systems, controlling feedback-sensitive processes, or modeling physical phenomena more efficiently than digital systems alone.

By combining the strengths of DNA and quantum computing, a hybrid computational paradigm can tackle complex problems more efficiently than either technology alone. This approach leverages the parallelism of DNA computing and quantum speed.

It is worth acknowledging that the detailed embodiments provided earlier are merely examples or potential embodiments of the hybrid computing system, and numerous other combinations, additions, or alternatives are plausible. The specific naming conventions for components, attributes, data structures, or any other programming or structural elements are also not obligatory or significant.

The mechanisms that implement the subject matter, or its features, may have different names, formats, or protocols. Additionally, the system can be implemented using a combination of hardware and software or solely with hardware components. The division of functionality among the various system components as described here is for illustrative purposes and is not set in stone.

Lastly, while this disclosure has been described in the context of various specific embodiments, it is important to recognize that it can be practiced with modifications within the spirit and scope of the claims.

Thus, specific embodiments of a hybrid Quantum/DNA computing process have been disclosed. It should be apparent, however, to those skilled in the art that many more modifications besides those described are possible without departing from the inventive concepts herein. The inventive subject matter, therefore, is not to be restricted except in the spirit of the appended claims.

1. A hybrid computing process comprising:
a binary computing system that is configured to interpret a problem and determine a first preferred method of solving said problem;
said binary computer system further including a quantum processing system;
and binary computer system also includes a DNA processing system;
said binary computer distributes said problem to said quantum processing system and said DNA processing system based upon a number of possible derivations to solve said problem.

2. The hybrid computing process according to claim 1, further includes error correction techniques with redundant DNA sequences and using enzymes to proofread and repair DNA.

3. The hybrid computing process according to claim 1, further includes using DNA for memory storage.

4. The hybrid computing process according to claim 3, further includes using a DNA reader to read said DNA stored in memory.

5. The hybrid computing process according to claim 1, wherein said quantum processing system reads qubit states.

6. The hybrid computing process according to claim 5, wherein Initialization of qubits involves cooling said qubits and applying a sequence of microwave pulses that places said qubits into a desired superpositions or entangled states.

7. The hybrid computing process according to claim 6, wherein said desired superpositions or entangled states provides control over pulse shape, duration, and frequency of said qubits.

8. The hybrid computing process according to claim 5, wherein reading said qubits states is by measuring the reflected microwave signal's phase and amplitude.

9. The hybrid computing process according to claim 7, includes two-qubits gates.

10. The hybrid computing process according to claim 9, wherein said two-qubits gates enable entangling gates to find a global minimum of said problem.

11. The hybrid computing process according to claim 1, wherein said quantum computer includes at least two cooling temperature stages.

12. The hybrid computing process according to claim 1, further includes a drive, a flux, a pump and an output.

13. The hybrid computing process according to claim 1, uses artificial intelligence for error correction.

14. The hybrid computing process according to claim 1, includes DNA-based storage.

15. The hybrid computing process according to claim 14, wherein said DNA-based storage includes a DNA storage module, a biochemical reaction chamber module and a quantum solver module.

16. The hybrid computing process according to claim 15, wherein said quantum solver module utilizes a quantum circuit simulator to identify optimal binary sequences from a candidate set that includes a superposition of all possible states.

17. The hybrid computing process according to claim 1, has a pre-processor that feeds into a quantum computing layer, then into DNA computation and then into a post-processor.

18. The hybrid computing process according to claim 1, has a quantum computing layer, that feed into a pre-processing, into a DNA processing system then into a post processor.

19. The hybrid computing process according to claim 1, having a pre-processor feeding in parallel into a quantum computing and a DNA processing and both said quantum computing and said DNA processing pass said problem into a post-processor.

20. The hybrid computing process according to claim 1, uses Shor's and Grover's algorithms quantum algorithms that use leverage superposition and entanglement to solve said problem.
